(19) United States
(12) Patent Application Publication
(10) Pub. No.: US 2026/0281819 A1
(43) Pub. Date: Sep. 17, 2026

(54) VARIABLE-BANDWIDTH FDM ALLOCATION

(71) Applicant: QUALCOMM Incorporated, San Diego, CA (US)

(72) Inventors: Raviteja PATCHAVA, San Diego, CA (US); Piyush GUPTA, Bridgewater, NJ (US); Junyi LI, Greentown, PA (US)

(21) Appl. No.: 19/079,235

(22) Filed: Mar. 13, 2025

(51) Int. Cl. H04W 28/18; H04L 5/00; H04W 52/14; H04W 52/36; H04W 72/044; H04W 72/0453; H04W 74/0833

(52) U.S. Cl. CPC H04W 28/18; H04L 5/0073; H04W 52/146; H04W 52/367; H04W 72/0453; H04W 72/0473; H04W 74/0833

(57) ABSTRACT

A method for wireless communication at a wireless device and related apparatus are provided. In the method, the wireless device receives a resource indication from a reader device. The resource indication includes a plurality of resource configurations, and each resource configuration of the plurality of resource configurations includes a frequency shift and a corresponding bandwidth. The wireless device further transmits to the reader device a first message for a random access procedure with the reader device using a first resource configuration of the plurality of resource configurations. The first resource configuration is based on a received power on the wireless device or a power variation between the wireless device and a neighboring device.

### TECHNICAL FIELD

The present disclosure relates generally to communication systems and, more particularly, to resource allocation for Internet of Things (IoT) devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a wireless device. The apparatus may include at least one memory and at least one processor coupled to the at least one memory. Based at least in part on information stored in the at least one memory, the at least one processor may be configured to receive, from a reader device, a resource indication including a plurality of resource configurations, where each resource configuration of the plurality of resource configurations includes a frequency shift and a corresponding bandwidth; and transmit, to the reader device, a first message for a random access procedure with the reader device using a first resource configuration of the plurality of resource configurations, where the first resource configuration is based on a received power on the wireless device or a power variation between the wireless device and a neighboring device.

In an aspect of the disclosure, a method, a computer-readable medium, and an apparatus are provided for wireless communication at a reader device. The apparatus may include at least one memory and at least one processor coupled to the at least one memory. Based at least in part on information stored in the at least one memory, the at least one processor may be configured to transmit, to a wireless device, a resource indication including a plurality of resource configurations, where each resource configuration of the plurality of resource configurations includes a frequency shift and a corresponding bandwidth; and receive, from the wireless device, a first message for a random access procedure with the wireless device using a first resource configuration of the plurality of resource configurations. The first resource configuration is based on a received power on the wireless device or a power variation between the wireless device and a neighboring device.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example radio frequency identification (RFID) system.

FIG. 5 is a diagram illustrating an example of the operation of an ambient Internet of Things (A-IoT) device.

FIG. 6 is a diagram illustrating an example of a random access procedure for an A-IoT device.

FIG. 7 is a diagram illustrating example interferences at odd harmonics.

FIG. 8 is a diagram illustrating an example of interference caused by sampling frequency offset (SFO).

FIG. 9 is a diagram illustrating an example of the allocation of different bandwidths in accordance with various aspects of the present disclosure.

FIG. 10 is a diagram illustrating an example of the power ramping process of a reader device in accordance with various aspects of the present disclosure.

FIG. 11 is a diagram illustrating an example of bandwidth allocation for different frequency shifts in accordance with various aspects of the present disclosure.

FIG. 12 is a call flow diagram illustrating a method of wireless communication in accordance with various aspects of the present disclosure.

FIG. 13 is a flowchart illustrating methods of wireless communication at a wireless device in accordance with various aspects of the present disclosure.

FIG. 14 is a flowchart illustrating methods of wireless communication at a reader device in accordance with various aspects of the present disclosure.

FIG. 15 is a diagram illustrating an example of a hardware implementation for an example apparatus and/or UE.

FIG. 16 is a diagram illustrating an example of a hardware implementation for an example network entity.

### DETAILED DESCRIPTION

Ambient Internet of Things (A-IoT) devices are smaller and less expensive Internet of Things (IoT) devices that can operate as passive devices or energy harvesting devices, utilizing radio waves as the primary power resource and eliminating the need for traditional battery-based systems. An A-IoT device may backscatter an incident radio frequency (RF) wave from a reader device, generating a backscattered signal that carries modulated bit information. An A-IoT device may use a random access procedure to establish communication with a reader device. The messages exchanged between a reader device and an A-IoT device during a random access procedure may include a first random access message (Msg) (e.g., Msg 1) transmitted from the A-IoT device to the reader device and a second random access message (e.g., Msg 2) transmitted from the reader device to the A-IoT device. In A-IoT devices, the frequency shift is generated through square wave modulation backscattering and applied to the messages transmitted to the reader device. However, this square wave modulation at the A-IoT device results in interference at certain frequency ranges. Additionally, the presence of sampling frequency offset (SFO) between the reader device and the A-IoT device may cause the backscattered signal to leak into neighboring frequencies, further contributing to interference. Example aspects presented herein provide methods and apparatus for allocating variable bandwidth based on frequency shift for messages in a random access procedure (e.g., Msg 1) to enhance resource allocation efficiency and reduce interference.

Various aspects relate generally to wireless communication. Some aspects more specifically relate to resource allocation for messages in random access procedures for A-IoT devices. In some examples, a wireless device (e.g., an A-IoT device) may receive a resource indication from a reader device. The resource indication includes a plurality of resource configurations, and each resource configuration of the plurality of resource configurations includes a frequency shift and a corresponding bandwidth. The wireless device (e.g., an A-IoT device) further transmits, to the reader device, a first message for a random access procedure with the reader device using a first resource configuration of the plurality of resource configurations. The first resource configuration is based on a received power on the wireless device or a power variation between the wireless device and a neighboring device. In some aspects, the first resource configuration may be based on the received power on the wireless device, and an increase in received power on the wireless device may correspond to an increase in frequency shift. In some aspects, the first resource configuration may be based on the power variation between the wireless device and a neighboring device.

Particular aspects of the subject matter described in this disclosure can be implemented to realize one or more of the following potential advantages. In some examples, by introducing variable bandwidth (BW) allocation for a random access message (e.g., Msg 1) of an A-IoT device and enabling dynamic adjustment of the bandwidth based on frequency shifts and device conditions, the described techniques enhance resource utilization efficiency and reduce interference. In some examples, by implementing device-side received power measurements, the described techniques enable adaptive resource allocation, allowing devices with higher received power to be assigned larger frequency shifts and bandwidths, thereby improving data rates and overall network efficiency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

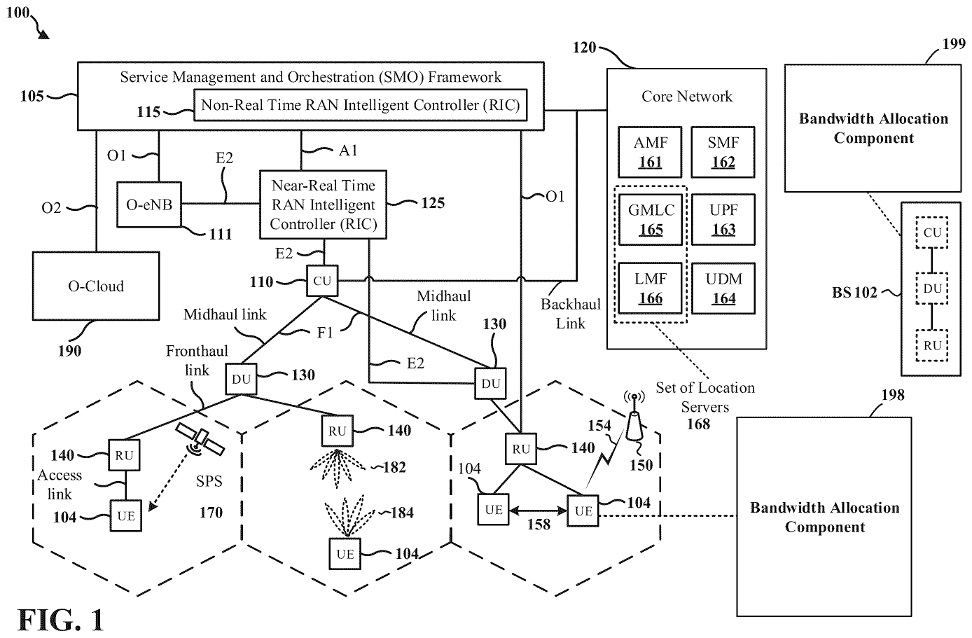

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the bandwidth allocation component 198. The bandwidth allocation component 198 may be configured to receive, from a reader device, a resource indication including a plurality of resource configurations, where each resource configuration of the plurality of resource configurations includes a frequency shift and a corresponding bandwidth; and transmit, to the reader device, a first message for a random access procedure with the reader device using a first resource configuration of the plurality of resource configurations. The first resource configuration may be based on a received power on the wireless device or a power variation between the wireless device and a neighboring device. In certain aspects, the base station 102 may include the bandwidth allocation component 199. The bandwidth allocation component 199 may be configured to transmit, to a wireless device, a resource indication including a plurality of resource configurations, where each resource configuration of the plurality of resource configurations includes a frequency shift and a corresponding bandwidth; and receive, from the wireless device, a first message for a random access procedure with the wireless device using a first resource configuration of the plurality of resource configurations. The first resource configuration may be based on a received power on the wireless device or a power variation between the wireless device and a neighboring device. Although the following description may be focused on 5G NR, the concepts described herein may be applicable to other similar areas, such as LTE, LTE-A, CDMA, GSM, and other wireless technologies.

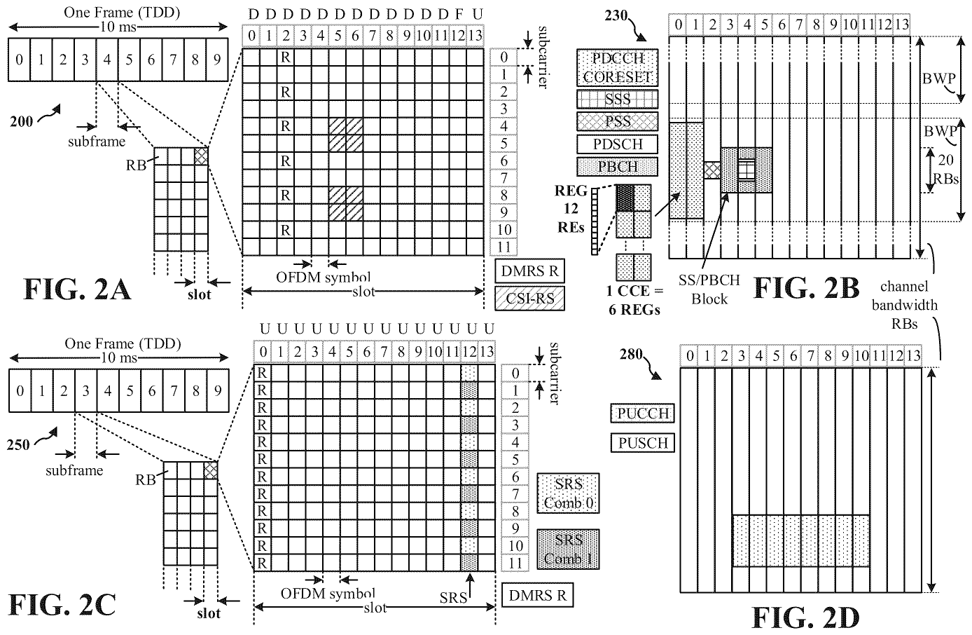

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

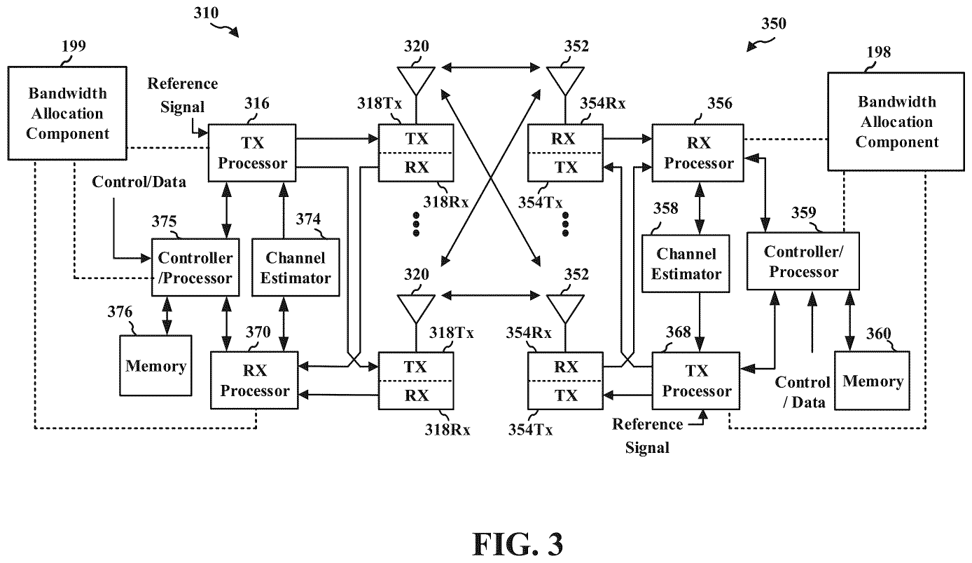

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the bandwidth allocation component 198 of FIG. 1.

At least one of the TX processor 316, the RX processor 370, and the controller/processor 375 may be configured to perform aspects in connection with the bandwidth allocation component 199 of FIG. 1.

Radio frequency identification (RFID) is a rapidly growing technology that has gained attention due to its potential to transform various industries, including inventory and asset management, IoT applications, sustainable sensor networks in factories and agriculture, and smart home systems.

At the core of RFID technology are small transponders, or tags, which emit information-bearing signals when activated by an external signal. These tags can be utilized to track, identify, and manage a wide range of objects and assets. One of the key benefits of RFID technology is its ability to function at low operating expenses (OPEX), low maintenance costs, and a long lifecycle.

Passive RFID systems, in particular, may harvest energy from ambient radio frequency waves and power the transmission and reception circuitry without the need for an internal battery. These systems may employ backscatter modulation for the transmitted signal, enabling the tags to operate with minimal power consumption. Besides passive RFID systems, semi-passive or active RFID systems may incorporate batteries to provide additional power and extended capabilities. However, these systems generally entail a higher cost.

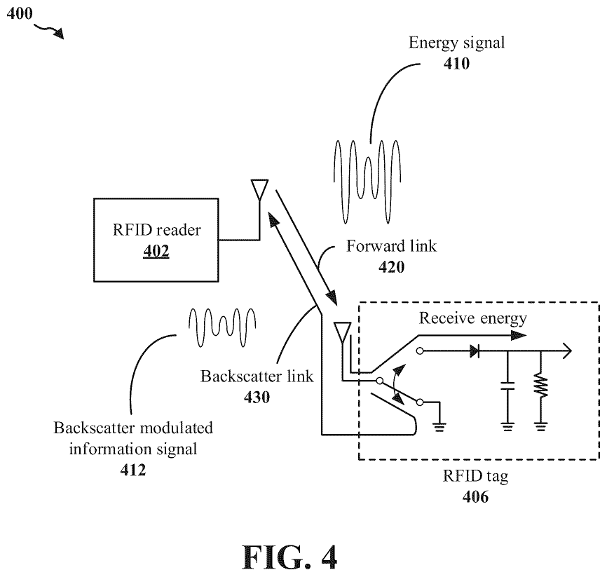

FIG. 4 is a diagram 400 illustrating an example RFID system. In FIG. 4, an RFID reader 402 (an electronic device that can communicate with an RFID tag and retrieve the information stored on it) may transmit an energy signal 410 to the RFID tag 406 via a forward link 420. The RFID tag 406 may reflect a backscatter modulated information signal 412 back to the RFID reader 402 via a backscatter link 430. This backscatter modulated information signal 412 may carry data that the RFID reader 402 may use for various purposes, such as identification verification and tracking.

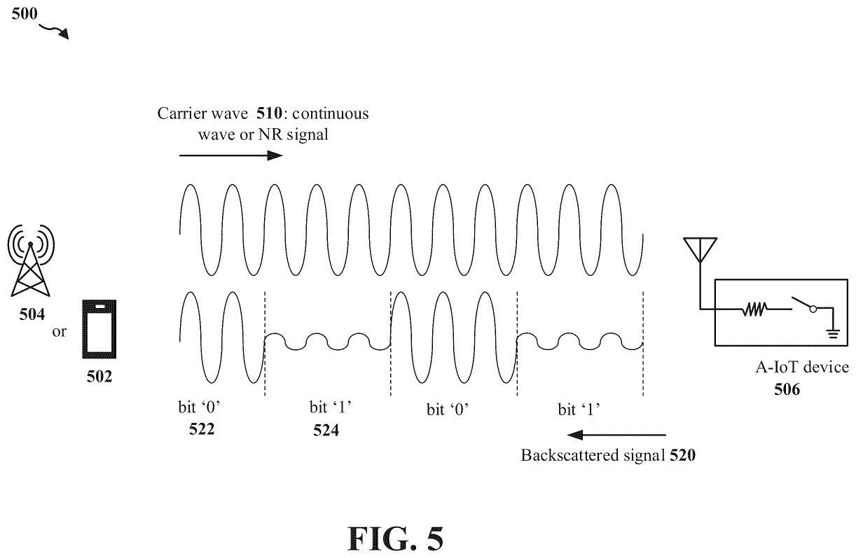

Ambient Internet of Things (A-IoT) devices are smaller and less expensive IoT devices than devices such as narrowband IoT (NB-IoT), LTE-M, and reduced capability (RedCap) devices. In some examples, A-IoT devices may operate as passive devices or energy harvesting devices that harness the energy from radio waves as the prime source of power, eliminating traditional battery-based systems. These A-IoT devices may be used in passive ultra-high frequency (UHF) RFID systems, in some examples. FIG. 5 is a diagram 500 illustrating an example of the operation of an A-IoT device. In FIG. 5, the A-IoT device 506 (which may also be referred to as an A-IoT UE, in some aspects) may harvest the energy from an incident RF wave 510, which may be transmitted from the base station 504 or UE 502, as the power source. The incident RF wave 510, which may be referred to as the carrier wave, may be the continuous wave for an NR signal transmission. Wireless devices transmitting the incident RF may be referred to as RF sources or simply sources. For example, in the example in FIG. 5, the base station 504 or UE 502 may function as an RF source.

The A-IoT device 506 may backscatter the incident RF wave 510 as a backscattered signal 520 back to a reader (e.g., which may be the base station 504 or UE 502, for example). In some examples, the backscattered signal 520 may be a modulated signal that carries bit information, such as bit ‘0’ 522 and bit ‘1’ 524. Wireless devices capable of receiving and interpreting the bit information from a backscattered signal may be referred to as RF readers or simply readers. For example, in FIG. 5, the UE 502 may function as an RF reader. In some aspects, the RF source and the RF reader may be the same device. In other aspects, the RF source may be a different device than the RF reader.

An A-IoT device (e.g., A-IoT device 506) may use a random access procedure in order to establish communication with a reader or reader device (e.g., base station 504 or UE 502). In some examples, random access procedures involving A-IoT devices (e.g., A-IoT device 506) may be triggered by a reader device (e.g., base station 504 or UE 502) since the A-IoT devices may not support radio resource control (RRC) configurations.

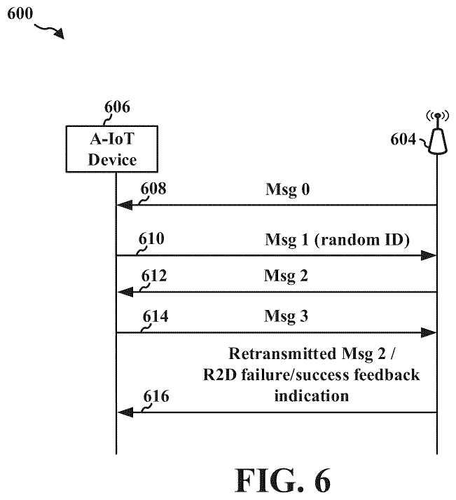

FIG. 6 is a diagram 600 illustrating a random access procedure between an A-IoT device and a reader device. As shown in FIG. 6, in the random access procedure, the A-IoT device 606 may, at 610, initiate communication by sending an identifier (ID) to the reader device (e.g., base station 604) in Msg 1. This ID may be a random ID generated by the A-IoT device 606. For example, the A-IoT device 606 may generate the random ID using methods such as random generation or generation based on the device ID. In some examples, before receiving Msg 1 at 610 from the A-IoT device 606, the reader device (e.g., base station 604) may transmit a query message (e.g., Msg 0) at 608. In some examples, the reader device (e.g., base station 604) may use the query message (e.g., Msg 0) to detect, identify, or request a response from nearby A-IoT devices.

Upon receiving Msg 1 from the A-IoT device 606, the reader device (e.g., base station 604) may echo the ID received in Msg 1. For example, the reader device (e.g., base station 604) may include the ID in Msg 2 to the A-IoT device 606 at 612. In some examples, Msg 2 may include additional information, such as the resource allocations for the A-IoT device 606 to transmit subsequent random access messages (e.g., Msg 3 at 614). Upon receiving Msg 2 from the reader device (e.g., base station 604), the A-IoT device 606 may send Msg 3 to the reader device (e.g., base station 604) at 614. In some examples, the A-IoT device 606 may include its device ID and/or any other upper layer data as specified by the upper layer request in Msg 3 at 614. The A-IoT device 606 may consider the contention resolution to be successful if it receives Msg 2 (e.g., at 612) containing the same random ID that was sent in Msg 1 (e.g., at 610). In some examples, an R2D transmission may be sent to the A-IoT device 606 at 616 after Msg 3 transmission at 614. In some examples, if the reader device (e.g., base station 604) fails to receive Msg 3 from A-IoT device 606, the reader device (e.g., base station 604) may retransmit Msg 2 at 616, which may contain the random ID of the A-IoT device 606 from which the reader device fails to receive Msg 3 at 614. In some examples, the reader device (e.g., base station 604) may transmit an R2D failure/success feedback indication at 616 to the A-IoT device 612 for re-access purposes.

In some examples, a reader device may initiate random access procedures with multiple A-IoT devices. For example, a reader device may trigger random access procedures with multiple A-IoT devices by sending a reader-to-device (R2D) transmission to multiple A-IoT devices. In this case, the reader device (e.g., base station 604) may receive multiple Msg 1 transmissions respectively from multiple A-IoT devices. The reader device may transmit Msg 2 to these A-IoT devices in different configurations. In some examples, a physical reader-to-device channel (PRDCH) for Msg 2 transmission may be provided for an A-IoT Msg 1 received from a single device. In some examples, a PRDCH may be provided for Msg 2 transmission corresponding to multiple A-IoT Msg 1 transmissions received from multiple devices.

One example application of an A-IoT includes an inventory procedure, in which a reader device, also referred to as a reader (e.g., a base station or user equipment (UE)), may detect and manage multiple A-IoT devices within its communication range. As an example, the inventory procedure for A-IoT devices may include multiple steps. First, the reader device (e.g., UE 502, base station 504, 604) may transmit a query message, referred to as Msg 0 to one or more A-IoT devices. The query message may include a selection criterion. In response, all A-IoT devices that match with (or meet) the selection criterion in the query message may transmit a random access message (e.g., Msg 1 at 610) back to the reader device (e.g., UE 502, base station 504, 604). As an example, the selection criterion may be related to a particular product (e.g., a product identifier). Upon receiving the random access message (e.g., Msg 1 at 610), the reader device (e.g., UE 502, base station 504, 604) then transmits another random access message (e.g., Msg 2 at 612), which allocates resources for A-IoT devices (e.g., A-IoT device 606) to transmit their electronic product code (EPC) identifier (ID). Following this allocation, the A-IoT devices (e.g., A-IoT device 606) may use the assigned resources from Msg 2 to transmit their EPC ID in a subsequent random access message (e.g., Msg 3 at 614). Then, the reader device (e.g., UE 502, base station 504, 604) may complete the inventory procedure by acknowledging the Msg 3 transmissions (e.g., Msg 3 at 614) from the A-IoT devices (e.g., A-IoT device 606). Example aspects presented herein provide methods and apparatus that enable the reader to allocate variable bandwidth based on frequency shift for Msg 1, depending on the specific scenarios. The scenarios considered for the bandwidth allocation may include device-side measurement, small power variation between devices, and high power variation between devices.

In some aspects, the bandwidth allocation methods presented herein may be applicable to the Msg 1 device-to-reader (D2R) transmission in an inventory procedure. For example, in an inventory procedure, the base station may allocate different multiplexing resources for A-IoT devices to facilitate Msg 1 transmission. These resources may include time division multiplexing (TDM) resources, frequency division multiplexing (FDM) resources, or code division multiplexing (CDM) resources. For example, FDM may be achieved by using different frequency shifts for backscattering at A-IoT devices, and CDM may be achieved through binary pseudo-noise (PN) sequence transmission from the A-IoT devices.

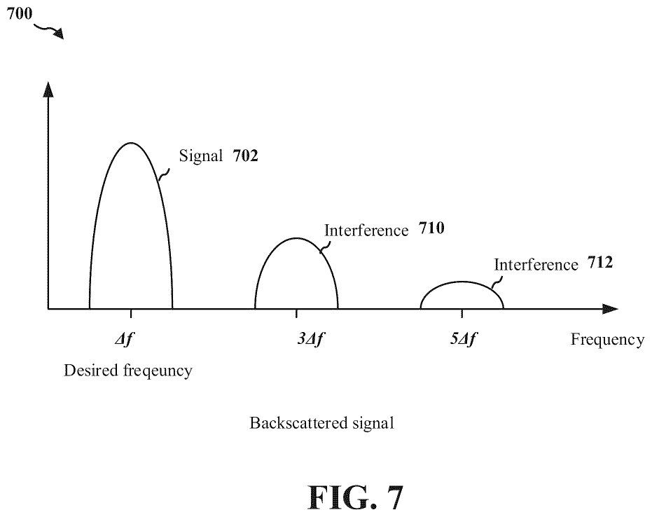

In some examples, upon receiving an incident RF wave (e.g., the incident RF wave 510), an A-IoT device (e.g., A-IoT device 506, 606) may generate a frequency shift through square wave modulation backscattering and apply the frequency shift on the backscattered signal (e.g., backscattered signal 520). However, this square wave modulation at the A-IoT device (e.g., A-IoT device 506, 606) can result in interference at odd harmonics, such as 3Δf, 5Δf, and 7Δf, where Δf is the desired frequency of the backscattered signal. FIG. 7 is a diagram 700 illustrating example interferences at odd harmonics. “Harmonics” refer to unwanted frequency components that occur at integer multiples of a fundamental frequency (e.g., Δf). As shown in FIG. 7, the level of interference may decrease as the frequency moves further away from Δf. In one example, the interference levels are measured at −9.5 dB at 3Δf (e.g., for interference 710), −14 dB at 5Δf (e.g., for interference 712), and −17 dB at 7Δf when compared to the desired signal level at Δf (e.g., signal 702). Additionally, due to the presence of sampling frequency offset (SFO) between the reader and the A-IoT device, which is the mismatch between the sampling frequency of the reader and the A-IoT device, the backscattered signal (e.g., backscattered signal 520) may be leaked into neighboring frequencies. This leakage may further contribute to interference on the communication between the reader and the A-IoT device.

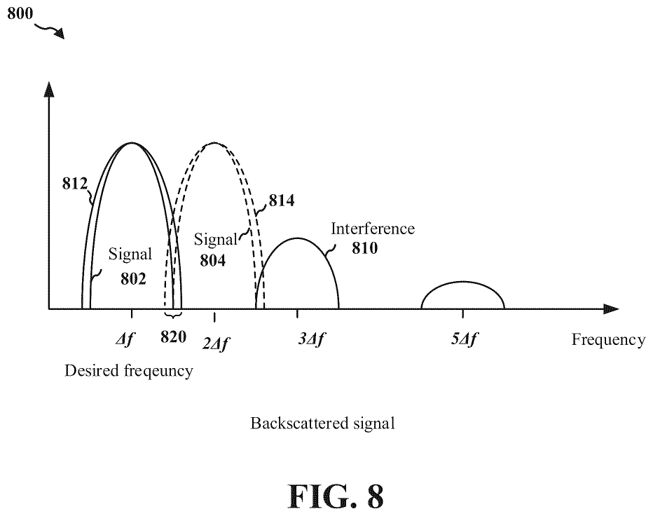

In some examples, to reduce interference, the frequency shifts assigned to A-IoT devices may be designed in a way that prevents the A-IoT devices from interfering with one another. For example, frequency shifts such as Δf, 2Δf, 4Δf, and 8Δf can be allocated to A-IoT devices to ensure that they do not interfere with the odd harmonics of each other. Additionally, generating a square wave with frequency shifts of powers of 2 may be implemented at the A-IoT device with relatively low hardware complexity. In some examples, interference may occur between Δf and 2Δf due to SFO. FIG. 8 is a diagram 800 illustrating an example of interference caused by SFO. As shown in FIG. 8, signal 802 has a frequency shift of Δf, and signal 804 has a frequency shift of 2Δf. In an ideal scenario, the signal 804 does not overlap with signal 802 and its odd harmonics (e.g., interference 810 at 3Δf) in the frequency domain. However, due to SFO, the frequency component of signal 802 may expand to its adjacent region (e.g., to 812), and the frequency component of signal 804 may expand to its adjacent region (e.g., to 814), leading to overlap with adjacent signals and causing interference, for example, within frequency range 820. To mitigate the interference due to SFO, larger frequency shifts, such as frequency shifts of Δf, 4Δf, and 8Δf, may be used. In this approach, all the frequency shifts may be allocated the same bandwidth. However, this approach may not fully utilize the available bandwidth due to the restrictions imposed on frequency shift and bandwidth.

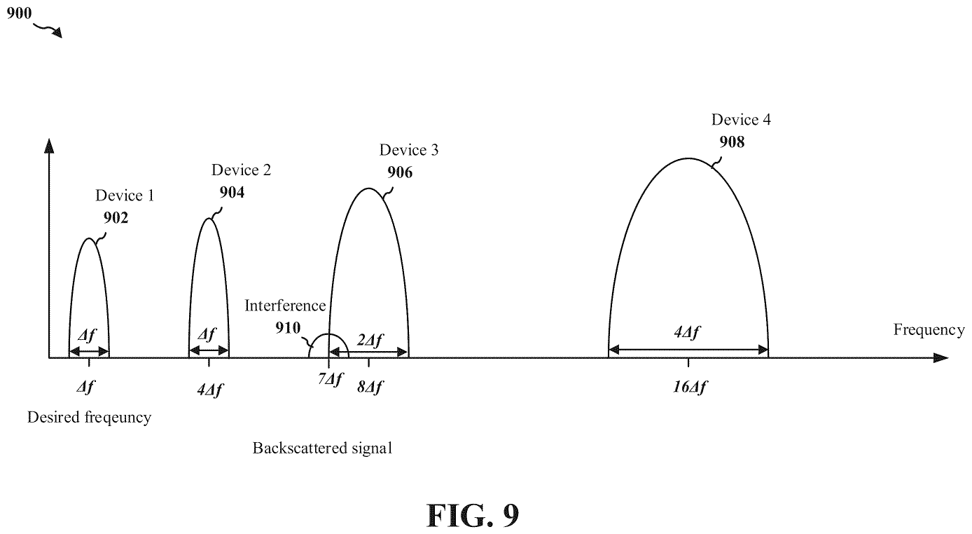

In some examples, to improve frequency utilization in D2R transmissions, particularly at higher frequency shifts, the reader may allocate different bandwidths for different frequency shifts. Higher bandwidths may be assigned to higher frequency shifts, allowing for improved data rates. For example, when using a frequency shift of 8Δf, the bandwidth of 2Δf or 4Δf may be supported. FIG. 9 is a diagram 900 illustrating the allocation of different bandwidths in accordance with various aspects of the present disclosure. As shown in FIG. 9, the reader may allocate the bandwidth of Δf for frequency shift of Δf (e.g., for Device 1 902) and the frequency shift of 4Δf (e.g., for Device 2 904). The reader may further allocate the bandwidth of 2Δf for the frequency shift of 8Δf (e.g., for Device 3 906) and allocate the bandwidth of 4Δf for the frequency shift of 16Δf (e.g., for Device 4 908).

However, increasing the bandwidth may lead to interference from other harmonics. For example, as shown in FIG. 9, frequency shift of 8Δf (e.g., for Device 3 906) may experience interference at 7Δf due to harmonics (e.g., Interference 910) of the transmission from a device (e.g., Device 1 902) using Δf, although the interference at 7Δf from Device 1 may be lower compared to the interference at a lower frequency (e.g., 3 Δf) from the same device. To mitigate interference caused by large bandwidths, the reader may allocate higher signal-to-noise ratio (SNR) devices with higher frequency shifts (e.g., 8Δf or 16Δf) and larger bandwidths (e.g., 4Δf), and allocate lower SNR devices with lower frequency shifts (e.g., Δf). In some examples, this approach is applicable in scenarios where the reader schedules resources based on SNR differences between devices, such as in Msg 3 transmissions (e.g., Msg 3 at 614) during the inventory procedure. Example aspects presented herein provide methods and apparatus that enable the reader to allocate variable bandwidth for random access transmissions, such as Msg 1, depending on the specific scenarios. For example, the allocation of variable bandwidth may be based on device-side measurement, small power variation between devices, or high power variation between devices.

In some aspects, the reader (e.g., UE 502, base station 504, 604) may allocate bandwidth based on frequency shift for a random access message (e.g., Msg 1 at 610) depending on specific scenarios (or conditions). One such scenario (or condition) may include device-side measurement, which may be obtained at A-IoT devices by measuring a received signal (or an input signal). In this case, the reader (e.g., UE 502, base station 504, 604) may allocate bandwidth and frequency shift based on the received power at the A-IoT devices. In some examples, A-IoT devices with higher received power may be allowed to transmit using higher frequency shifts (e.g., 8Δf) and larger bandwidths (e.g., 4Δf). Table 2 shows examples of resource allocations (e.g., frequency shifts and bandwidths) for devices with various SNRs.

TABLE 2
Examples of resource allocations (frequency shifts and bandwidths)
for devices with various SNRs

| Frequency | | | | |
|---|---|---|---|---|
| shift | Resource Allocations | | | |
| 8Δf | Resource 3 | Resource 4 | Resource 5 | Resource 6 |
| | (high SNR) | (high SNR) | (high SNR) | (high SNR) |
| | bandwidth | bandwidth | bandwidth | bandwidth |
| | of 4Δf | of 4Δf | of 4Δf | of 4Δf |

| | |
|---|---|
| 4Δf | Resource 2 (low SNR, high SNR), bandwidth of Δf |
| Δf | Resource 1 (low SNR), bandwidth of Δf |

In some examples, some frequency shifts may be assigned to both low and high SNR devices, depending on the interference impact. For example, as shown in Table 2, the frequency shift of 4Δf may be assigned to both low and high SNR devices.

In some aspects, when no code division multiplexing (CDM) is employed, a higher bandwidth may allow the reader (e.g., UE 502, base station 504, 604) to allocate multiple time division multiplexing (TDM) resources at higher frequency shifts for the same time duration compared to lower frequency shifts. For example, four TDM resources may be assigned at 8Δf, whereas one TDM resource may be allocated at Δf. In some aspects, when CDM is employed, a higher bandwidth may enable the use of longer sequence lengths and allow the multiplexing of a higher number of A-IoT devices for CDM transmission.

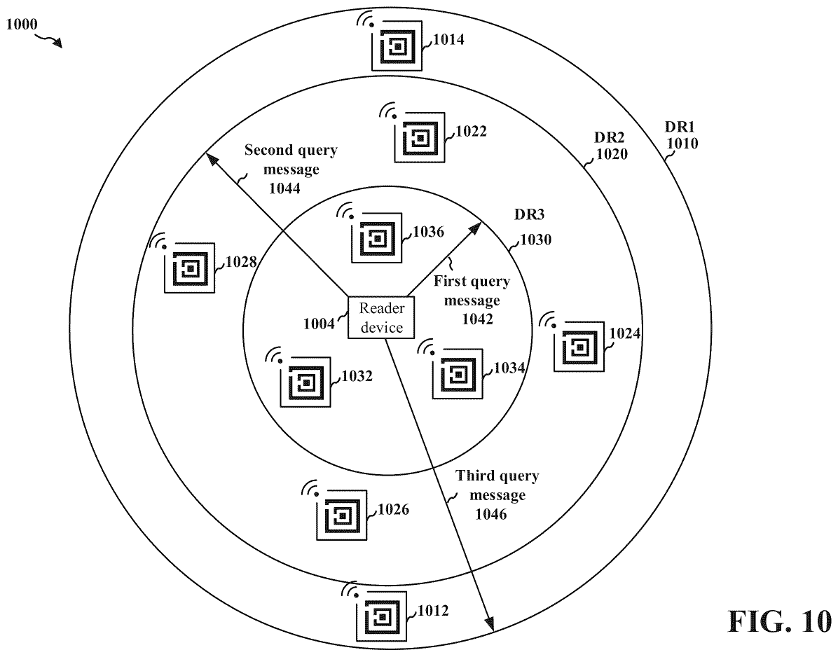

In some aspects, the reader (e.g., UE 502, base station 504, 604) may allocate bandwidth based on frequency shift for a random access message (e.g., Msg 1 at 610) depending on a small power variation between A-IoT devices. For example, the reader (e.g., UE 502, base station 504, 604) may implement a power ramping process to control the power variation between the A-IoT devices. FIG. 10 is a diagram 1000 illustrating an example of a power ramping process of a reader device in accordance with various aspects of the present disclosure. As shown in FIG. 10, in an example power ramping process, the reader 1004 may initially transmit a query message (e.g., the first query message 1042) with a lower transmit power (e.g., DR3 1030). Due to the low received power, the A-IoT devices that are located near the reader 1004 (e.g., A-IoT devices 1032, 1034, 1036) may receive this query message (e.g., the first query message 1042) and respond with Msg 1, and the power difference between responding A-IoT devices (e.g., A-IoT devices 1032, 1034, 1036) may be small. Then, the reader 1004 may gradually increase the transmit power to extend coverage to farther A-IoT devices. For example, the reader 1004 may increase the transmit power to DR2 1020 to transmit another query message (e.g., the second query message 1044), which may reach the A-IoT devices (e.g., A-IoT devices 1022, 1024, 1026, 1028) that are located farther away from the reader 1004. These A-IoT devices (e.g., A-IoT devices 1022, 1024, 1026, 1028) may respond with Msg 1 upon receiving this query message (e.g., the second query message 1044). However, A-IoT devices that have already responded to the previous query message (e.g., the first query message 1042), such as A-IoT devices 1032, 1034, 1036, may not respond again, ensuring that the power difference among responding A-IoT devices (e.g., A-IoT devices 1022, 1024, 1026, 1028) remains minimal. Similarly, the reader 1004 may further increase the transmit power to DR1 1010 to transmit yet another query message (e.g., the third query message 1046), which may reach the A-IoT devices located even further away (e.g., A-IoT devices 1012, 1014) from the reader 1004. These A-IoT devices (e.g., A-IoT devices 1012, 1014) may respond with Msg 1 upon receiving this query message (e.g., the third query message 1046), and A-IoT devices that have already responded to any of the previous query messages (e.g., the first query message 1042 and the second query message 1044), such as A-IoT devices 1032, 1034, 1036, 1022, 1024, 1026, 1028, may not respond again, ensuring that the power difference among responding A-IoT devices (e.g., A-IoT devices 1012, 1014) remains minimal.

In this scenario, the reader (e.g., UE 502, base station 504, 604) may allocate bandwidth based on frequency shift, and each A-IoT device may select one resource (e.g., one bandwidth) from the allocated resources (e.g., the allocated bandwidths). For example, referring to FIG. 10, the reader 1004 may allocate a first set of resources (e.g., bandwidth and frequency shift) for A-IoT devices 1032, 1034, 1036, which respond to the first query message. Each of these A-IoT devices (e.g., A-IoT devices 1032, 1034, 1036) may select one resource (e.g., one bandwidth) from the allocated first set of resources. The reader 1004 may further allocate a second set of resources (e.g., bandwidth and frequency shift) for A-IoT devices 1022, 1024, 1026, 1028, which respond to the second query message. Each of these A-IoT devices (e.g., A-IoT devices 1022, 1024, 1026, 1028) may select one resource (e.g., one bandwidth) from the allocated second set of resources.

In some examples, higher frequency shifts may support a greater number of resources due to the availability of higher bandwidth. In some examples, when CDM is employed, a larger number of sequences may be allocated with higher frequency shifts. On the other hand, compared to bandwidth allocation based on device-side measurement, the bandwidth allocation at higher frequency shifts may be lower in this scenario due to the smaller power variation among A-IoT devices.

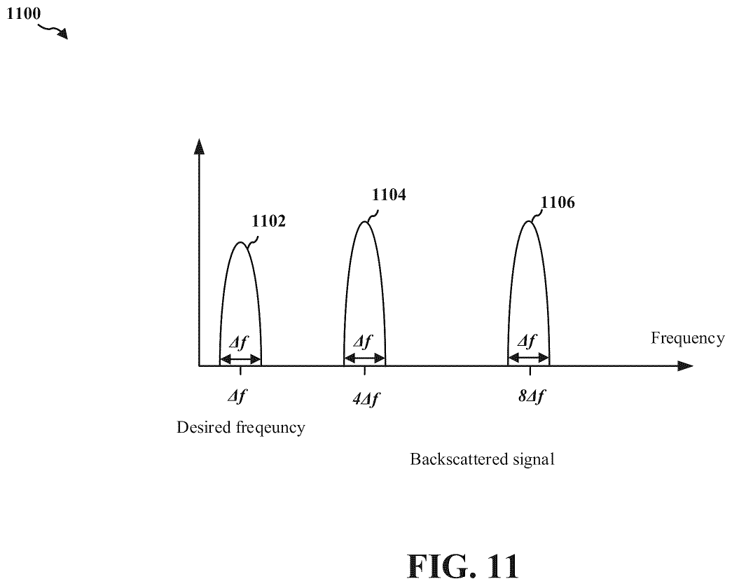

In some aspects, the reader (e.g., UE 502, base station 504, 604) may allocate bandwidth based on frequency shift for a random access message (e.g., Msg 1 at 610) based on a high power variation between A-IoT devices. In this case, no power control mechanism among the A-IoT devices (e.g., the transmission of multiple query messages with increasing transmit power) is employed, and resource allocation on higher bandwidth may not be supported due to interference. As a result, all frequency shifts may be assigned the same bandwidth to mitigate interference and maintain stable communication. FIG. 11 is a diagram 1100 illustrating an example of bandwidth allocation for different frequency shifts in accordance with various aspects of the present disclosure. As shown in FIG. 11, when the reader (e.g., UE 502, base station 504, 604) allocate resources (e.g., bandwidths and frequency shift) for a random access message (e.g., Msg 1 at 610) among A-IoT devices with a high power variation, all frequency shifts (e.g., Δf at 1102, 4Δf at 1104, and 8Δf at 1106) may be assigned the same bandwidth (e.g., Δf).

In some aspects, to facilitate the variable bandwidth allocation for a random access message (e.g., Msg 1 at 610), the query message (e.g., Msg 0 at 608, the first query message 1042, the second query message 1044, the third query message 1046) may include resource information related to resource allocation for the random access message (e.g., Msg 1 at 610). For example, the resource information in the query message may indicate the frequency shifts that are allowed for the transmission of the random access message (e.g., Msg 1 at 610) and the bandwidth allocated for each frequency shift. In some examples, the resource information may specify the TDM resource allocation for each frequency shift. In some examples, when the reader (e.g., UE 502, base station 504, 604) allocates bandwidth based on frequency shift for a random access message (e.g., Msg 1 at 610), and there is high power variation between A-IoT devices and no power control on the reader is employed, the bandwidth and TDM allocation may remain the same for all frequency shifts.

In some examples, when CDM is employed, the resource information in the query message (e.g., Msg 0 at 608, the first query message 1042, the second query message 1044, the third query message 1046) may specify the number of sequences allowed for each frequency shift. In some examples, when the resource allocation (or bandwidth allocation) is based on device-side received power measurements, the resource information in the query message may include received power thresholds for each frequency shift. In some examples, each frequency shift may be assigned two thresholds: a lower power threshold P₁ and an upper power threshold P₂. An A-IoT device may select the appropriate frequency shift based on the received power thresholds. For example, An A-IoT device may select a frequency shift if the measured received power falls within the range [P₁, P₂] corresponding to this frequency shift. In some examples, some or all of the resource information in the query message (e.g., Msg 0) may be pre-configured on the A-IoT device, the reader device, or both.

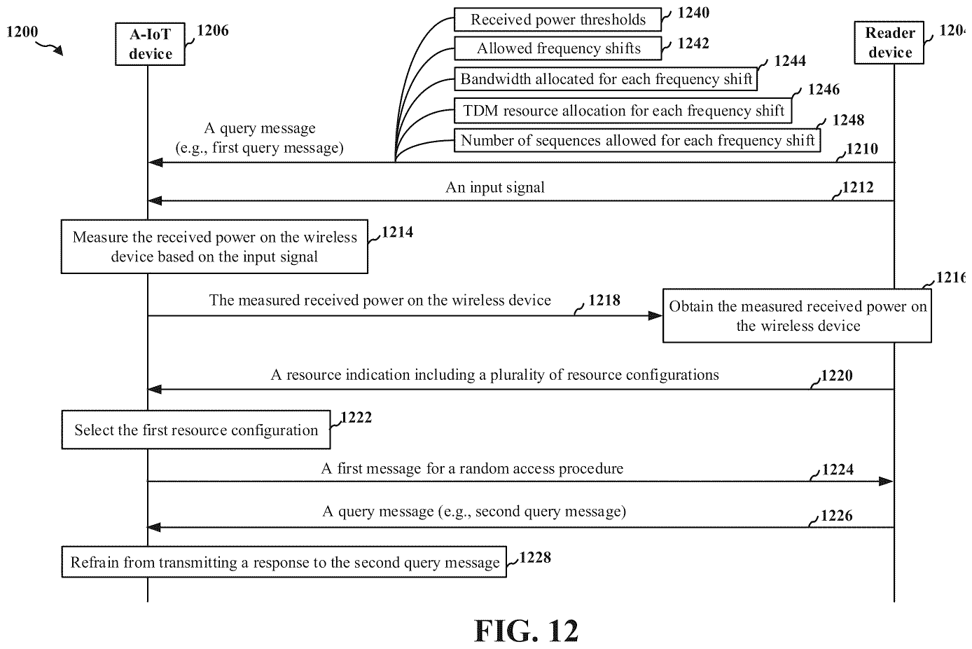

FIG. 12 is a call flow diagram 1200 illustrating a method of wireless communication in accordance with various aspects of this present disclosure. Various aspects are described in connection with a reader device 1204 and a wireless device 1206. The aspects may be performed by the reader device 1204 or the wireless device 1206. In some examples, the wireless device 1206 may be a wireless tag or an IoT device, such as RFID tag 406 or A-IoT device 506, 606. In some examples, the reader device 1204 may be RFID reader 402, UE 104, 350, 502, or base station 504, 604.

As shown in FIG. 12, at 1210, the wireless device 1206 may receive a query message from the reader device 1204. For example, the query message may be the query message (e.g., Msg 0) at 608, the first query message 1042, the second query message 1044, or the third query message 1046. In some examples, the query message may include received power threshold (e.g., at 1240), which may include an upper power threshold and a lower power threshold for each frequency shift for each resource configuration in a plurality of resource configurations the wireless device 1206 may use from transmitting the first message (e.g., at 1224) for a random access procedure between the wireless device 1206 and the reader device 1204. In some examples, the query message may include resource information for the first message (e.g., at 1224) for a random access procedure between the wireless device 1206 and the reader device 1204. For example, the resource information may include one or more of a set of allowed frequency shifts (e.g., at 1242) for the transmission of the first message at 1224, a set of bandwidths allocated for each frequency shift (e.g., at 1244) in the plurality of resource configurations, a TDM resource allocation for each frequency shift in the plurality of resource configurations (e.g., at 1246), or the number of sequences allowed for each frequency shift in the plurality of resource configurations for CDM (e.g., at 1248).

In some examples, the wireless device 1206 may receive an input signal at 1212. For example, the input signal may be from the reader device 1204.

In some examples, the wireless device 1206 may, at 1214, measure the received power on the wireless device based on the input signal. In some examples, the measured received power may facilitate the wireless device 1212 to select (e.g., at 1222) a proper resource configuration for transmitting the first message (e.g., at 1224).

In some examples, the reader device 1204 may, at 1216, obtain the measured received power on the wireless device 1206. For example, after measuring the received power at 1214, the wireless device 1206 may transmit the measured received power to the reader device 1204 at 1218.

At 1220, the reader device 1204 may transmit a resource indication including a plurality of resource configurations to the wireless device 1206. Each resource configuration of the plurality of resource configurations may include a frequency shift and a corresponding bandwidth for transmitting the first message at 1224. For example, referring to Table 2, in some examples, the plurality of resource configurations may include a first frequency shift of Δf with the corresponding bandwidth of Δf, a second frequency shift of 4Δf with the corresponding bandwidth of Δf, and a third frequency shift of 8Δf with the corresponding bandwidth of 4Δf. In some examples, the reader device 1204 may allocate bandwidth and frequency shift based on the received power at wireless device 1206.

At 1222, the wireless device 1206 may select one resource configuration (e.g., the first resource configuration) from the plurality of resource configurations, and, at 1224, transmit the first message of the random access procedure between the wireless device 1206 and the reader device 1204. In some examples, the first message may be Msg 1 at 610. In some examples, the wireless device 1206 may select a resource configuration from the plurality of resource configurations based on a comparison of the measured received power (e.g., at 1214) and the received power thresholds (e.g., at 1240). For example, the received power thresholds may include an upper power threshold and a lower power threshold for every frequency shift in the plurality of resource configurations. If the measured received power on the wireless device 1206 falls within a range defined by a lower power threshold and an upper power threshold, the wireless device 1206 may select a resource configuration, where the frequency shift in the selected resource configuration corresponds to the lower power threshold and the upper power threshold that define the range encompassing the measured received power.

In some examples, the reader device 1204 may use a power ramping scheme when transmitting the query message to nearby wireless devices (e.g., A-IoT devices). For example, the reader device 1204 may initially transmit a first query message (e.g., at 1210) with a lower transmit power, resulting in a relatively small coverage range and a small power difference among the wireless devices that can receive the first query message. Then, the reader device 1204 may gradually increase the transmit power to extend coverage to farther wireless devices. For example, the reader device 1204 may transmit another query message at 1226 with increased transmit power, expanding the coverage range of the second query message to reach more distant wireless devices. In this case, if the wireless device 1206 has already transmitted a first message to the reader device 1204 (e.g., at 1210) as a response to the first query message, the wireless device 1206 may, at 1228, refrain from transmitting a response to the second query message.

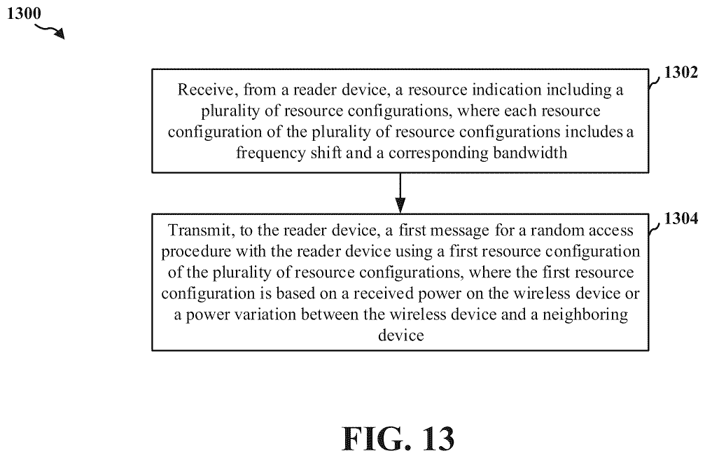

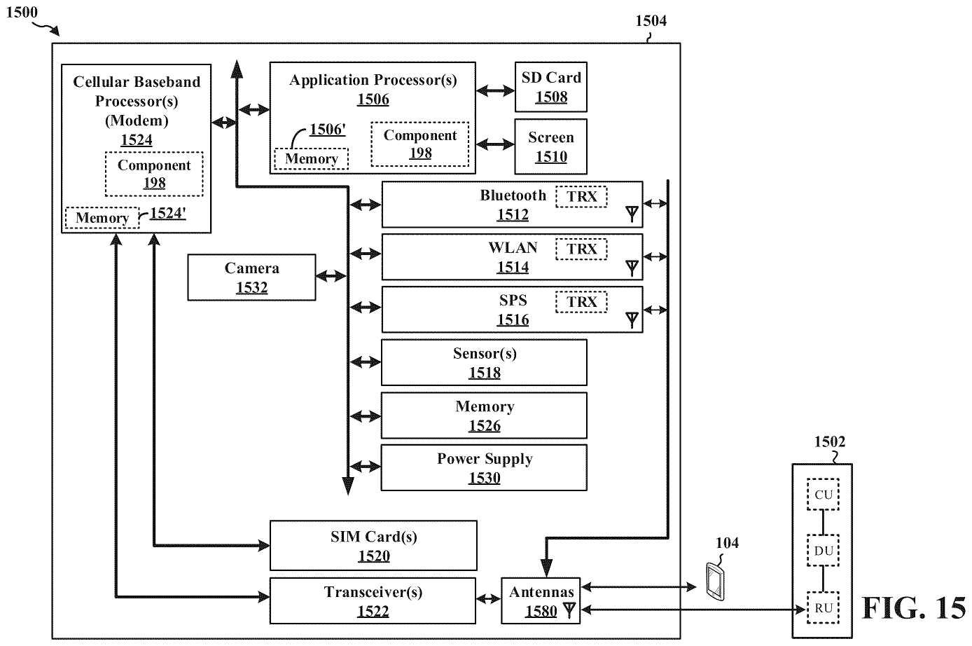

FIG. 13 is a flowchart 1300 illustrating methods of wireless communication at a wireless device in accordance with various aspects of the present disclosure. In some examples, the wireless device may be a wireless tag (e.g., RFID tag 406) or an IoT device (e.g., A-IoT device 506, 606). For example, the wireless device may be a low-power IoT device, which may include a backscatter device or an active transmission device. In some examples, the wireless device may be a UE. In some examples, the wireless device may be the wireless device 1206. The method may be performed by the wireless device in collaboration with a reader device 1204. In some examples, the reader device may be another UE (e.g., UE 502) that is different from the wireless device. In some examples, the reader device may be a network entity. The network entity may be a base station, or a component of a base station, in the access network of FIG. 1 or a core network component (e.g., base station 102, 310, 504, 604; or the network entity 1502 in the hardware implementation of FIG. 15). The UE may be the UE 104, 350, or the apparatus 1504 in the hardware implementation of FIG. 15. By introducing variable bandwidth allocation for a random access message (e.g., Msg 1) of an A-IoT device and enabling dynamic adjustment of the bandwidth based on frequency shifts and device conditions, the methods enhance resource utilization efficiency and reduce interference. Additionally, by implementing device-side received power measurements, the methods enable adaptive resource allocation, allowing devices with higher received power to be assigned larger frequency shifts and bandwidths, thereby improving data rates and overall network efficiency.

As shown in FIG. 13, at 1302, the wireless device may receive a resource indication from a reader device. The resource indication may include a plurality of resource configurations, and each resource configuration of the plurality of resource configurations may include a frequency shift and a corresponding bandwidth. FIG. 9, FIG. 10, FIG. 11, and FIG. 12 illustrate various aspects of the steps in connection with flowchart 1300. For example, referring to FIG. 12, the wireless device 1206 may, at 1220, receive a resource indication from a reader device 1204. The resource indication may include a plurality of resource configurations, and each resource configuration of the plurality of resource configurations may include a frequency shift and a corresponding bandwidth. Referring to Table 2, in some examples, the plurality of resource configurations may include a first frequency shift of Δf with the corresponding bandwidth of Δf, a second frequency shift of 4Δf with the corresponding bandwidth of Δf, and a third frequency shift of 8Δf with the corresponding bandwidth of 4Δf. In some aspects, 1302 may be performed by the bandwidth allocation component 198.

At 1304, the wireless device may transmit, to the reader device, a first message for a random access procedure with the reader device using a first resource configuration of the plurality of resource configurations. The first resource configuration may be based on a received power on the wireless device or a power variation between the wireless device and a neighboring device. For example, referring to FIG. 12, the wireless device 1206 may, at 1224, transmit to the reader device 1204 a first message for a random access procedure with the reader device 1204 using a first resource configuration of the plurality of resource configurations. The first resource configuration may be based on a received power on the wireless device 1206 or a power variation between the wireless device 1206 and a neighboring device. Referring to FIG. 10, the power variation may be the power variation between two neighboring devices, such as A-IoT devices 1032 and 1034. In some aspects, 1304 may be performed by the bandwidth allocation component 198.

In some aspects, the plurality of resource configurations may include the first resource configuration and a second resource configuration. The first resource configuration may include a first frequency shift and a first bandwidth, and the second resource configuration may include a second frequency shift and a second bandwidth. The first bandwidth may be greater than or equal to the second bandwidth if the first frequency shift is greater than the second frequency shift. For example, referring to Table 2, the first bandwidth (e.g., 4Δf for Resource 3) may be greater than or equal to the second bandwidth (e.g., Δf for Resource 2) if the first frequency shift (e.g., 8Δf for Resource 3) is greater than the second frequency shift (e.g., 4Δf for Resource 2).

In some aspects, the first resource configuration may be based on the received power on the wireless device, and an increase in received power on the wireless device corresponds to an increase in frequency shift. For example, referring to FIG. 12, the first resource configuration may be based on the received power (e.g., measured at 1214) on the wireless device 1206, and an increase in received power on the wireless device corresponds to an increase in frequency shift.

In some aspects, the wireless device may receive an input signal; and measure the received power on the wireless device based on the input signal. For example, referring to FIG. 12, the wireless device 1206 may, at 1212, receive an input signal; and, at 1214, measure the received power on the wireless device 1206 based on the input signal.

In some aspects, the wireless device may receive, from the reader device, an upper power threshold and a lower power threshold for the frequency shift for each resource configuration in the plurality of resource configurations; and select the frequency shift of the first resource configuration based on a comparison of the received power, the upper power threshold, and the lower power threshold for the frequency shift for each resource configuration in the plurality of resource configurations. For example, referring to FIG. 12, the wireless device 1206 may, at 1210, receive from the reader device 1204 an upper power threshold and a lower power threshold (e.g., received power thresholds at 1240) for the frequency shift for each resource configuration in the plurality of resource configurations. The wireless device 1206 may, at 1222, select the frequency shift of the first resource configuration based on a comparison of the received power, the upper power threshold, and the lower power threshold for the frequency shift for each resource configuration in the plurality of resource configurations.

In some aspects, to select the frequency shift of the first resource configuration, the wireless device may select the frequency shift of the first resource configuration when the received power on the wireless device is within a range defined by the lower power threshold and the upper power threshold for the frequency shift of the first resource configuration. For example, referring to FIG. 12, the wireless device 1206 may, at 1222, select the frequency shift of the first resource configuration when the received power on the wireless device is within a range defined by the lower power threshold and the upper power threshold for the frequency shift of the first resource configuration.

In some aspects, the plurality of resource configurations may be based on the SNR of the wireless device. For example, referring to Table 2, the plurality of resource configurations may be based on the SNR of the wireless device. For example, the wireless devices with high SNR may be provided with higher frequency shifts (e.g., 8Δf), and the wireless devices with low SNR may be provided with lower frequency shifts (e.g., Δf).

In some aspects, the first resource configuration may be based on the power variation between the wireless device and the neighboring device, and the wireless device may select the first resource configuration from the plurality of resource configurations. For example, referring to FIG. 10 and FIG. 12, the first resource configuration may be based on the power variation between the wireless device and the neighboring device, such as between the A-IoT devices 1032 and 1034, and the wireless device 1206 may, at 1222, select the first resource configuration from the plurality of resource configurations.

In some aspects, the wireless device may receive, from the reader device, a first query message with a first transmit power, and the transmission of the first message for the random access procedure with the reader device may be based on the first query message. For example, referring to FIG. 10 and FIG. 12, the wireless device (e.g., A-IoT device 1032) may receive, from the reader 1004, a first query message 1042 with a first transmit power (e.g., DR3 1030), and the transmission of the first message (e.g., at 1224) for the random access procedure with the reader device may be based on the first query message 1042.

In some aspects, the wireless device may receive, from the reader device, a second query message with a second transmit power higher than the first transmit power. The wireless device may refrain from transmitting a response to the second query message based on the transmission of the first message. For example, referring to FIG. 10, the wireless device (e.g., A-IoT device 1032) may receive, from the reader 1004, a second query message 1044 with a second transmit power (e.g., DR2 1044) higher than the first transmit power (e.g., DR3 1042). The wireless device (e.g., A-IoT device 1032) may refrain from transmitting a response to the second query message 1044 based on the transmission of the first message.

In some aspects, the first resource configuration may be based on the power variation between the wireless device and the neighboring device, and the plurality of resource configurations may include the same bandwidth. For example, referring to FIG. 11, the first resource configuration may be based on the power variation between the wireless device and the neighboring device, and the plurality of resource configurations may include the same bandwidth (e.g., the bandwidth of Δf for frequency shifts of Δf, 4Δf, and 8Δf).

In some aspects, the wireless device may receive, from the reader device, a query message including resource information for the first message. To transmit the first message for the random access procedure with the reader device, the wireless device may transmit the first message for the random access procedure with the reader device based on the resource information. For example, referring to FIG. 12, the wireless device 1206 may, at 1210, receive from the reader device 1204 a query message including resource information for the first message. To transmit the first message for the random access procedure with the reader device (e.g., at 1224), the wireless device 1206 may transmit the first message for the random access procedure with the reader device based on the resource information.

In some aspects, the resource information may include one or more of: a set of allowed frequency shifts for a transmission of the first message, or a set of bandwidths allocated for each frequency shift in the plurality of resource configurations. For example, referring to FIG. 12, the resource information may include one or more of: a set of allowed frequency shifts for a transmission of the first message (e.g., at 1242), or a set of bandwidths allocated for each frequency shift in the plurality of resource configurations (e.g., at 1244).

In some aspects, the resource information may further include one or more of: a TDM resource allocation for each frequency shift in the plurality of resource configurations, or a number of sequences allowed for each frequency shift in the plurality of resource configurations for CDM. For example, referring to FIG. 12, the resource information may further include one or more of: a TDM resource allocation for each frequency shift in the plurality of resource configurations (e.g., at 1246), or a number of sequences allowed for each frequency shift in the plurality of resource configurations for CDM (e.g., at 1248).

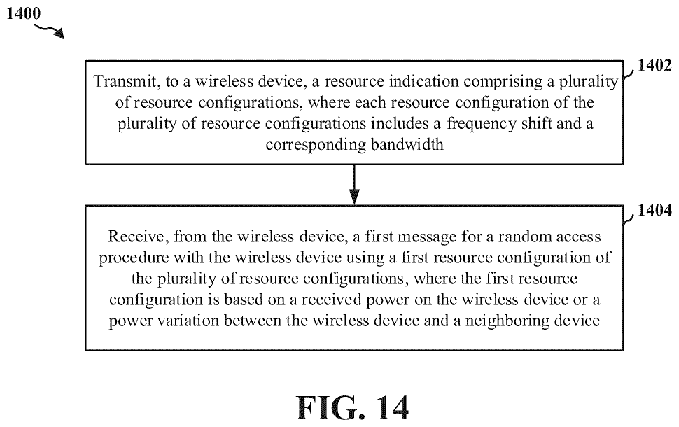

FIG. 14 is a flowchart 1400 illustrating methods of wireless communication at a reader device in accordance with various aspects of the present disclosure. In some aspects, the reader device may be a UE. The UE may be the UE 104, 350, 502 or the apparatus 1504 in the hardware implementation of FIG. 15. In some aspects, the reader device may be reader device 1204. In some examples, the reader device may be a network entity. The network entity may be a base station, or a component of a base station, in the access network of FIG. 1 or a core network component (e.g., base station 102, 310, 504, 604; or the network entity 1502 in the hardware implementation of FIG. 15). In some examples, the wireless device may be a wireless tag (e.g., RFID tag 406) or an IoT device (e.g., A-IoT device 506, 606). For example, the wireless device may be a low-power IoT device, which may include a backscatter device or an active transmission device. In some examples, the wireless device may be a UE. In some examples, the wireless device may be the wireless device 1206. The method may be performed by the reader device in collaboration with a wireless device. By introducing variable bandwidth allocation for a random access message (e.g., Msg 1) of an A-IoT device and enabling dynamic adjustment of the bandwidth based on frequency shifts and device conditions, the methods enhance resource utilization efficiency and reduce interference. Additionally, by implementing device-side received power measurements, the methods enable adaptive resource allocation, allowing devices with higher received power to be assigned larger frequency shifts and bandwidths, thereby improving data rates and overall network efficiency.

As shown in FIG. 14, at 1402, the reader device may transmit, to the wireless device, a resource indication including a plurality of resource configurations. Each resource configuration of the plurality of resource configurations may include a frequency shift and a corresponding bandwidth. FIG. 9, FIG. 10, FIG. 11, and FIG. 12 illustrate various aspects of the steps in connection with flowchart 1400. For example, referring to FIG. 12, the reader device 1204 may, at 1220, transmit to the wireless device 1206 a resource indication including a plurality of resource configurations. Each resource configuration of the plurality of resource configurations may include a frequency shift and a corresponding bandwidth. Referring to Table 2, in some examples, the plurality of resource configurations may include a first frequency shift of Δf with the corresponding bandwidth of Δf, a second frequency shift of 4Δf with the corresponding bandwidth of Δf, and a third frequency shift of 8Δf with the corresponding bandwidth of 4Δf. In some aspects, 1402 may be performed by the bandwidth allocation component 199.

At 1404, the reader device may receive, from the wireless device, a first message for a random access procedure with the wireless device using a first resource configuration of the plurality of resource configurations. The first resource configuration may be based on a received power on the wireless device or a power variation between the wireless device and a neighboring device. For example, referring to FIG. 12, the reader device 1204 may, at 1224, receive, from the wireless device 1206, a first message for a random access procedure with the wireless device using a first resource configuration of the plurality of resource configurations. The first resource configuration may be based on a received power on the wireless device 1206 or a power variation between the wireless device 1206 and a neighboring device. Referring to FIG. 10, the power variation may be the power variation between two neighboring devices, such as A-IoT devices 1032 and 1034. In some aspects, 1404 may be performed by the bandwidth allocation component 199.

In some aspects, the plurality of resource configurations may include the first resource configuration and a second resource configuration, and the first resource configuration may include a first frequency shift and a first bandwidth. The second resource configuration may include a second frequency shift and a second bandwidth. The first bandwidth may be greater than or equal to the second bandwidth if the first frequency shift is greater than the second frequency shift. For example, referring to Table 2, the first bandwidth (e.g., 4Δf for Resource 3) may be greater than or equal to the second bandwidth (e.g., Δf for Resource 2) if the first frequency shift (e.g., 8Δf for Resource 3) is greater than the second frequency shift (e.g., 4Δf for Resource 2).

In some aspects, the first resource configuration may be based on the received power on the wireless device, and an increase in received power on the wireless device may correspond to an increase in frequency shift. For example, referring to FIG. 12, the first resource configuration may be based on the received power (e.g., measured at 1214) on the wireless device 1206, and an increase in received power on the wireless device corresponds to an increase in frequency shift.

In some aspects, the reader device may transmit, to the wireless device, an upper power threshold and a lower power threshold for the frequency shift for each resource configuration in the plurality of resource configurations. The received power on the wireless device may be within a range defined by the lower power threshold and the upper power threshold for the frequency shift of the first resource configuration. For example, referring to FIG. 12, the reader device 1204 may, at 1210, transmit to the wireless device 1206 an upper power threshold and a lower power threshold (e.g., received power thresholds at 1240) for the frequency shift for each resource configuration in the plurality of resource configurations. The received power on the wireless device 1206 may be within a range defined by the lower power threshold and the upper power threshold for the frequency shift of the first resource configuration.

In some aspects, the reader device may transmit a first query message with a first transmit power; and transmit a second query message with a second transmit power higher than the first transmit power. The reception of the first message for the random access procedure may be based on one of the first query message or the second query message. For example, referring to FIG. 12, the reader device 1204 may, at 1210, transmit a first query message with a first transmit power; and, at 1226, transmit a second query message with a second transmit power higher than the first transmit power. The reception of the first message (e.g., at 1224) for the random access procedure may be based on one of the first query message or the second query message.

In some aspects, the reader device may transmit, to the wireless device, a query message including resource information for the first message. The reception of the first message for the random access procedure may be based on the resource information. For example, referring to FIG. 12, the reader device 1204 may, at 1210, transmit, to the wireless device 1206, a query message including resource information for the first message. The reception of the first message for the random access procedure may be based on the resource information.

In some aspects, the resource information may include one or more of: a set of allowed frequency shifts for a transmission of the first message, or a set of bandwidths allocated for each frequency shift in the plurality of resource configurations. For example, referring to FIG. 12, the resource information may include one or more of: a set of allowed frequency shifts for a transmission of the first message (e.g., at 1242), or a set of bandwidths allocated for each frequency shift in the plurality of resource configurations (e.g., at 1244).

In some aspects, the resource information may further include one or more of: a TDM resource allocation for each frequency shift in the plurality of resource configurations, or a number of sequences allowed for each frequency shift in the plurality of resource configurations for CDM. For example, referring to FIG. 12, the resource information may further include one or more of: a TDM resource allocation for each frequency shift in the plurality of resource configurations (e.g., at 1246), or a number of sequences allowed for each frequency shift in the plurality of resource configurations for CDM (e.g., at 1248).

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor (or processing circuitry) 1524 (also referred to as a modem) coupled to one or more transceivers 1522 (e.g., cellular RF transceiver). The cellular baseband processor(s) (or processing circuitry) 1524 may include at least one on-chip memory (or memory circuitry) 1524′. In some aspects, the apparatus 1504 may further include one or more subscriber identity modules (SIM) cards 1520 and at least one application processor (or processing circuitry) 1506 coupled to a secure digital (SD) card 1508 and a screen 1510. The application processor(s) (or processing circuitry) 1506 may include on-chip memory (or memory circuitry) 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) (or processing circuitry) 1524 communicates through the transceiver(s) 1522 via one or more antennas 1580 with the UE 104 and/or with an RU associated with a network entity 1502. The cellular baseband processor(s) (or processing circuitry) 1524 and the application processor(s) (or processing circuitry) 1506 may each include a computer-readable medium/memory (or memory circuitry) 1524′, 1506′, respectively. The additional memory modules 1526 may also be considered a computer-readable medium/memory (or memory circuitry). Each computer-readable medium/memory (or memory circuitry) 1524′, 1506′, 1526 may be non-transitory. The cellular baseband processor(s) (or processing circuitry) 1524 and the application processor(s) (or processing circuitry) 1506 are each responsible for general processing, including the execution of software stored on the computer-readable medium/memory (or memory circuitry). The software, when executed by the cellular baseband processor(s) (or processing circuitry) 1524/application processor(s) (or processing circuitry) 1506, causes the cellular baseband processor(s) (or processing circuitry) 1524/application processor(s) (or processing circuitry) 1506 to perform the various functions described supra. The cellular baseband processor(s) (or processing circuitry) 1524 and the application processor(s) (or processing circuitry) 1506 are configured to perform the various functions described supra based at least in part of the information stored in the memory (or memory circuitry). That is, the cellular baseband processor(s) (or processing circuitry) 1524 and the application processor(s) (or processing circuitry) 1506 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1524/application processor(s) (or processing circuitry) 1506 when executing software. The cellular baseband processor(s) (or processing circuitry) 1524/application processor(s) (or processing circuitry) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) (or processing circuitry) 1524 and/or the application processor(s) (or processing circuitry) 1506, and in another configuration, the apparatus 1504 may be the entire UE (e.g., see UE 350 of FIG. 3) and include the additional modules of the apparatus 1504.

As discussed supra, the component 198 may be configured to receive, from a reader device, a resource indication including a plurality of resource configurations, where each resource configuration of the plurality of resource configurations includes a frequency shift and a corresponding bandwidth; and transmit, to the reader device, a first message for a random access procedure with the reader device using a first resource configuration of the plurality of resource configurations, where the first resource configuration is based on a received power on the wireless device or a power variation between the wireless device and a neighboring device. The component 198 may be further configured to perform any of the aspects described in connection with the flowchart in FIG. 13, and/or performed by the wireless device 1206 in FIG. 12. The component 198 may be within the cellular baseband processor(s) (or processing circuitry) 1524, the application processor(s) (or processing circuitry) 1506, or both the cellular baseband processor(s) (or processing circuitry) 1524 and the application processor(s) (or processing circuitry) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) (or processing circuitry) 1524 and/or the application processor(s) (or processing circuitry) 1506, includes means for receiving, from a reader device, a resource indication including a plurality of resource configurations, where each resource configuration of the plurality of resource configurations includes a frequency shift and a corresponding bandwidth; and means for transmitting, to the reader device, a first message for a random access procedure with the reader device using a first resource configuration of the plurality of resource configurations, where the first resource configuration is based on a received power on the wireless device or a power variation between the wireless device and a neighboring device. The apparatus 1504 may further include means for performing any of the aspects described in connection with the flowchart in FIG. 13, and/or aspects performed by the wireless device 1206 in FIG. 12. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

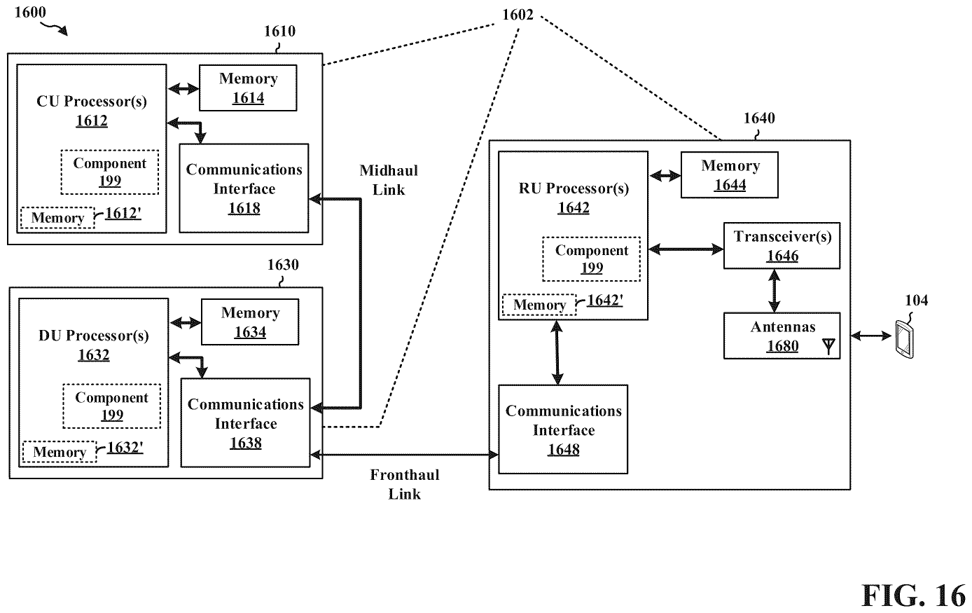

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor (or processing circuitry) 1612. The CU processor(s) (or processing circuitry) 1612 may include on-chip memory (or memory circuitry) 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor (or processing circuitry) 1632. The DU processor(s) (or processing circuitry) 1632 may include on-chip memory (or memory circuitry) 1632′. In some aspects, the DU 1630 may further include additional memory modules 1634 and a communications interface 1638. The DU 1630 communicates with the RU 1640 through a fronthaul link. The RU 1640 may include at least one RU processor (or processing circuitry) 1642. The RU processor(s) (or processing circuitry) 1642 may include on-chip memory (or memory circuitry) 1642′. In some aspects, the RU 1640 may further include additional memory modules 1644, one or more transceivers 1646, antennas 1680, and a communications interface 1648. The RU 1640 communicates with the UE 104. The on-chip memory (or memory circuitry) 1612′, 1632′, 1642′ and the additional memory modules 1614, 1634, 1644 may each be considered a computer-readable medium/memory (or memory circuitry). Each computer-readable medium/memory (or memory circuitry) may be non-transitory. Each of the processors (or processing circuitry) 1612, 1632, 1642 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, to a wireless device, a resource indication including a plurality of resource configurations, where each resource configuration of the plurality of resource configurations includes a frequency shift and a corresponding bandwidth; and receive, from the wireless device, a first message for a random access procedure with the wireless device using a first resource configuration of the plurality of resource configurations. The first resource configuration is based on a received power on the wireless device or a power variation between the wireless device and a neighboring device. The component 199 may be further configured to perform any of the aspects described in connection with the flowchart in FIG. 14, and/or performed by the reader device 1204 in FIG. 12. The component 199 may be within one or more processors (or processing circuitry) of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 includes means for transmitting, to a wireless device, a resource indication including a plurality of resource configurations, where each resource configuration of the plurality of resource configurations includes a frequency shift and a corresponding bandwidth; and means for receiving, from the wireless device, a first message for a random access procedure with the wireless device using a first resource configuration of the plurality of resource configurations. The first resource configuration is based on a received power on the wireless device or a power variation between the wireless device and a neighboring device. The network entity 1602 may further include means for performing any of the aspects described in connection with the flowchart in FIG. 14, and/or aspects performed by the reader device 1204 in FIG. 12. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a wireless device. The method may include receiving, from a reader device, a resource indication including a plurality of resource configurations, where each resource configuration of the plurality of resource configurations includes a frequency shift and a corresponding bandwidth; and transmitting, to the reader device, a first message for a random access procedure with the reader device using a first resource configuration of the plurality of resource configurations. The first resource configuration may be based on a received power on the wireless device or a power variation between the wireless device and a neighboring device. By introducing variable bandwidth allocation for a random access message (e.g., Msg 1) of an A-IoT device and enabling dynamic adjustment of the bandwidth based on frequency shifts and device conditions, the methods enhance resource utilization efficiency and reduce interference. Additionally, by implementing device-side received power measurements, the methods enable adaptive resource allocation, allowing devices with higher received power to be assigned larger frequency shifts and bandwidths, thereby improving data rates and overall network efficiency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device. The method includes receiving, from a reader device, a resource indication comprising a plurality of resource configurations, wherein each resource configuration of the plurality of resource configurations includes a frequency shift and a corresponding bandwidth; and transmitting, to the reader device, a first message for a random access procedure with the reader device using a first resource configuration of the plurality of resource configurations, wherein the first resource configuration is based on a received power on the wireless device or a power variation between the wireless device and a neighboring device.

Aspect 2 is the method of aspect 1, wherein the plurality of resource configurations includes the first resource configuration and a second resource configuration, the first resource configuration includes a first frequency shift and a first bandwidth, and the second resource configuration includes a second frequency shift and a second bandwidth, and wherein the first bandwidth is greater than or equal to the second bandwidth if the first frequency shift is greater than the second frequency shift.

Aspect 3 is the method of any of aspects 1 to 2, wherein the first resource configuration is based on the received power on the wireless device, and wherein an increase in received power on the wireless device corresponds to an increase in frequency shift.

Aspect 4 is the method of aspect 3, where the method further includes receiving an input signal; and measuring the received power on the wireless device based on the input signal.

Aspect 5 is the method of aspect 4, where the method further includes receiving, from the reader device, an upper power threshold and a lower power threshold for the frequency shift for each resource configuration in the plurality of resource configurations; and selecting the frequency shift of the first resource configuration based on a comparison of the received power, the upper power threshold, and the lower power threshold for the frequency shift for each resource configuration in the plurality of resource configurations.

Aspect 6 is the method of aspect 5, wherein selecting the frequency shift of the first resource configuration comprises selecting the frequency shift of the first resource configuration in response to the received power on the wireless device being within a range defined by the lower power threshold and the upper power threshold for the frequency shift of the first resource configuration.

Aspect 7 is the method of any of aspects 1 to 6, wherein the plurality of resource configurations is based on a signal-to-noise ratio (SNR) on the wireless device.

Aspect 8 is the method of aspect 2, wherein the first resource configuration is based on the power variation between the wireless device and the neighboring device, and wherein the method further includes selecting the first resource configuration from the plurality of resource configurations.

Aspect 9 is the method of aspect 8, wherein the method further includes receiving, from the reader device, a first query message with a first transmit power, wherein a transmission of the first message for the random access procedure with the reader device is based on the first query message.

Aspect 10 is the method of aspect 9, where the method further includes receiving, from the reader device, a second query message with a second transmit power higher than the first transmit power; and refraining from transmitting a response to the second query message based on the transmission of the first message.

Aspect 11 is the method of aspect 2, wherein the first resource configuration is based on the power variation between the wireless device and the neighboring device, and wherein the plurality of resource configurations includes a same bandwidth.

Aspect 12 is the method of any of aspects 1 to 2, wherein the method further includes receiving, from the reader device, a query message comprising resource information for the first message, wherein transmitting the first message for the random access procedure with the reader device comprises transmitting, based on the resource information, the first message for the random access procedure with the reader device.

Aspect 13 is the method of aspect 12, wherein the resource information includes one or more of a set of allowed frequency shifts for a transmission of the first message, or a set of bandwidths allocated for each frequency shift in the plurality of resource configurations.

Aspect 14 is the method of aspect 13, wherein the resource information further comprises one or more of a time division multiplexing (TDM) resource allocation for each frequency shift in the plurality of resource configurations, or a number of sequences allowed for each frequency shift in the plurality of resource configurations for code division multiplexing (CDM).

Aspect 15 is an apparatus for wireless communication at a wireless device, comprising: at least one memory; and at least one processor coupled to the at least one memory, the at least one processor is configured to perform the method of any of aspects 1 to 14.

Aspect 16 is the apparatus for wireless communication at a wireless device, comprising means for performing each step in the method of any of aspects 1-14.

Aspect 17 is an apparatus of any of aspects 15-16, further comprising a transceiver configured to receive or to transmit in association with the method of any of aspects 1-14.

Aspect 18 is a computer-readable medium (e.g., a non-transitory computer-readable medium) storing computer executable code at a wireless device, the code when executed by at least one processor causes the at least one processor to perform the method of any of aspects 1-14.

Aspect 19 is a method of wireless communication at a reader device. The method includes transmitting, to a wireless device, a resource indication comprising a plurality of resource configurations, wherein each resource configuration of the plurality of resource configurations includes a frequency shift and a corresponding bandwidth; and receiving, from the wireless device, a first message for a random access procedure with the wireless device using a first resource configuration of the plurality of resource configurations, wherein the first resource configuration is based on a received power on the wireless device or a power variation between the wireless device and a neighboring device.

Aspect 20 is the method of aspect 19, wherein the plurality of resource configurations includes the first resource configuration and a second resource configuration, the first resource configuration includes a first frequency shift and a first bandwidth, and the second resource configuration includes a second frequency shift and a second bandwidth, and wherein the first bandwidth is greater than or equal to the second bandwidth if the first frequency shift is greater than the second frequency shift.

Aspect 21 is the method of aspect 20, wherein the first resource configuration is based on the received power on the wireless device, and wherein an increase in received power on the wireless device corresponds to an increase in frequency shift.

Aspect 22 is the method of any of aspects 20 to 21, wherein the method further includes transmitting, to the wireless device, an upper power threshold and a lower power threshold for the frequency shift for each resource configuration in the plurality of resource configurations, and wherein the received power on the wireless device is within a range defined by the lower power threshold and the upper power threshold for the frequency shift of the first resource configuration.

Aspect 23 is the method of aspect 20, wherein the method further includes transmitting a first query message with a first transmit power; and transmitting a second query message with a second transmit power higher than the first transmit power, wherein a reception of the first message for the random access procedure is based on one of the first query message or the second query message.

Aspect 24 is the method of aspect 23, wherein the method further includes transmitting, to the wireless device, a query message comprising resource information for the first message, wherein the reception of the first message for the random access procedure is based on the resource information.

Aspect 25 is the method of aspect 24, wherein the resource information includes one or more of a set of allowed frequency shifts for a transmission of the first message, or a set of bandwidths allocated for each frequency shift in the plurality of resource configurations.

Aspect 26 is the method of aspect 25, wherein the resource information further comprises one or more of a time division multiplexing (TDM) resource allocation for each frequency shift in the plurality of resource configurations, or a number of sequences allowed for each frequency shift in the plurality of resource configurations for code division multiplexing (CDM).

Aspect 27 is an apparatus for wireless communication at a reader device, comprising: at least one memory; and at least one processor coupled to the at least one memory and, where the at least one processor is configured to perform the method of any of aspects 19-26.

Aspect 28 is the apparatus for wireless communication at a reader device, comprising means for performing each step in the method of any of aspects 19-26.

Aspect 29 is an apparatus of any of aspects 27-28, further comprising a transceiver configured to receive or to transmit in association with the method of any of aspects 19-26.

Aspect 30 is a computer-readable medium (e.g., a non-transitory computer-readable medium) storing computer executable code at a reader device, the code when executed by at least one processor causes the at least one processor to perform the method of any of aspects 19-26.

What is claimed is:

1. An apparatus for wireless communication at a wireless device, comprising:
at least one memory; and
at least one processor coupled to the at least one memory and, based at least in part on information stored in the at least one memory, the at least one processor is configured to:
receive, from a reader device, a resource indication comprising a plurality of resource configurations, wherein each resource configuration of the plurality of resource configurations includes a frequency shift and a corresponding bandwidth; and
transmit, to the reader device, a first message for a random access procedure with the reader device using a first resource configuration of the plurality of resource configurations, wherein the first resource configuration is based on a received power on the wireless device or a power variation between the wireless device and a neighboring device.

2. The apparatus of claim 1, further comprising a transceiver coupled to the at least one processor, wherein to receive the resource indication, the at least one processor is configured to receive the resource indication via the transceiver, wherein the plurality of resource configurations includes the first resource configuration and a second resource configuration, the first resource configuration includes a first frequency shift and a first bandwidth, and the second resource configuration includes a second frequency shift and a second bandwidth, and wherein the first bandwidth is greater than or equal to the second bandwidth if the first frequency shift is greater than the second frequency shift.

3. The apparatus of claim 2, wherein the first resource configuration is based on the received power on the wireless device, and wherein an increase in received power on the wireless device corresponds to an increase in frequency shift.

4. The apparatus of claim 3, wherein the at least one processor is further configured to:
receive an input signal; and
measure the received power on the wireless device based on the input signal.

5. The apparatus of claim 4, wherein the at least one processor is further configured to:
receive, from the reader device, an upper power threshold and a lower power threshold for the frequency shift for each resource configuration in the plurality of resource configurations; and
select the frequency shift of the first resource configuration based on a comparison of the received power, the upper power threshold, and the lower power threshold for the frequency shift for each resource configuration in the plurality of resource configurations.

6. The apparatus of claim 5, wherein to select the frequency shift of the first resource configuration, the at least one processor is configured to:
select the frequency shift of the first resource configuration in response to the received power on the wireless device being within a range defined by the lower power threshold and the upper power threshold for the frequency shift of the first resource configuration.

7. The apparatus of claim 3, wherein the plurality of resource configurations is based on a signal-to-noise ratio (SNR) on the wireless device.

8. The apparatus of claim 2, wherein the first resource configuration is based on the power variation between the wireless device and the neighboring device, and wherein the at least one processor is further configured to:
select the first resource configuration from the plurality of resource configurations.

9. The apparatus of claim 8, wherein the at least one processor is further configured to:
receive, from the reader device, a first query message with a first transmit power, wherein a transmission of the first message for the random access procedure with the reader device is based on the first query message.

10. The apparatus of claim 9, wherein the at least one processor is further configured to:
receive, from the reader device, a second query message with a second transmit power higher than the first transmit power; and
refrain from transmitting a response to the second query message based on the transmission of the first message.

11. The apparatus of claim 2, wherein the first resource configuration is based on the power variation between the wireless device and the neighboring device, and wherein the plurality of resource configurations includes a same bandwidth.

12. The apparatus of claim 2, wherein the at least one processor is further configured to:
receive, from the reader device, a query message comprising resource information for the first message, wherein to transmit the first message for the random access procedure with the reader device, the at least one processor is configured to:
transmit, based on the resource information, the first message for the random access procedure with the reader device.

13. The apparatus of claim 12, wherein the resource information includes one or more of:
a set of allowed frequency shifts for a transmission of the first message, or
a set of bandwidths allocated for each frequency shift in the plurality of resource configurations.

14. The apparatus of claim 13, wherein the resource information further comprises one or more of:
a time division multiplexing (TDM) resource allocation for each frequency shift in the plurality of resource configurations, or
a number of sequences allowed for each frequency shift in the plurality of resource configurations for code division multiplexing (CDM).

15. An apparatus for wireless communication at a reader device, comprising:
at least one memory; and
at least one processor coupled to the at least one memory and, based at least in part on information stored in the at least one memory, the at least one processor is configured to:
transmit, to a wireless device, a resource indication comprising a plurality of resource configurations, wherein each resource configuration of the plurality of resource configurations includes a frequency shift and a corresponding bandwidth; and
receive, from the wireless device, a first message for a random access procedure with the wireless device using a first resource configuration of the plurality of resource configurations, wherein the first resource configuration is based on a received power on the wireless device or a power variation between the wireless device and a neighboring device.

16. The apparatus of claim 15, further comprising a transceiver coupled to the at least one processor, wherein to transmit the resource indication, the at least one processor is configured to transmit the resource indication via the transceiver, wherein the plurality of resource configurations includes the first resource configuration and a second resource configuration, the first resource configuration includes a first frequency shift and a first bandwidth, and the second resource configuration includes a second frequency shift and a second bandwidth, and wherein the first bandwidth is greater than or equal to the second bandwidth if the first frequency shift is greater than the second frequency shift.

17. The apparatus of claim 16, wherein the first resource configuration is based on the received power on the wireless device, and wherein an increase in received power on the wireless device corresponds to an increase in frequency shift.

18. The apparatus of claim 16, wherein the at least one processor is further configured to:
transmit a first query message with a first transmit power; and
transmit a second query message with a second transmit power higher than the first transmit power, wherein a reception of the first message for the random access procedure is based on one of the first query message or the second query message.

19. The apparatus of claim 18, wherein the at least one processor is further configured to:
transmit, to the wireless device, a query message comprising resource information for the first message, wherein the reception of the first message for the random access procedure is based on the resource information, and wherein the resource information includes one or more of:
a set of allowed frequency shifts for a transmission of the first message,
a set of bandwidths allocated for each frequency shift in the plurality of resource configurations,
a time division multiplexing (TDM) resource allocation for each frequency shift in the plurality of resource configurations, or
a number of sequences allowed for each frequency shift in the plurality of resource configurations for code division multiplexing (CDM).

20. A method of wireless communication at a wireless device, comprising:
receiving, from a reader device, a resource indication comprising a plurality of resource configurations, wherein each resource configuration of the plurality of resource configurations includes a frequency shift and a corresponding bandwidth; and
transmitting, to the reader device, a first message for a random access procedure with the reader device using a first resource configuration of the plurality of resource configurations, wherein the first resource configuration is based on a received power on the wireless device or a power variation between the wireless device and a neighboring device.
